(19) United States
(12) Patent Application Publication
(10) Pub. No.: US 2007/0000493 A1
(43) Pub. Date: Jan. 4, 2007

(54) Apparatus for maintaining airway patency

(76) Inventor: Kingsley James Cox, Stony Brook, NY (US)

Correspondence Address: Daniel P. Burke, Esq.;GALGANO & BURKE, LLP, Suite 135, 300 Rabro Drive, Hauppauge, NY, 11754, US

(21) Appl. No.: 11/446,344

(22) Filed: Jun. 1, 2006

Related U.S. Application Data
(60) Provisional application No. 60/686,290, filed on Jun. 1, 2005.

(51) Int. Cl. A62B 7/00

(52) U.S. Cl. 128/204.23

(57) ABSTRACT

Apparatus comprising a mask with integral air pressure generating device(s) maintains an elevated air pressure supply to the nose and/or mouth which facilitates the airway to remain open.

### REFERENCE TO RELATED APPLICATIONS

This application claims priority on U.S. Provisional Patent Application Ser. No. 60/686,290, filed Jun. 1, 2005.

The present invention is directed to apparatus for maintaining airway patency and, more particularly, to apparatus for maintaining a positive airway pressure to alleviate breathing problems, for example, those experienced by people suffering from sleep apnea.

### BACKGROUND OF THE INVENTION

Sleep apnea is a common disorder affecting 3% or more of the population. When an affected individual sleeps, the tissue around the nasopharyngeal airway can lose muscle tone and partially collapse causing a blockage of the airway. The person stops breathing, sometimes for as long as a minute, before waking up. Apneic episodes can be very frequent with several hundred per night resulting in a serious lowering in the blood oxygen and subsequent stress on the heart. One of the hallmarks of Obstructive Sleep Apnea (OSA) is snoring. Snoring in itself may not cause blood oxygen desaturations but can be associated with brief awakenings which can cause poor quality sleep. Snoring occurs as a result of the muscle relaxation and partial blockage of the airways.

Solutions to this problem of airway blockage include surgery, nasal and oral stenting devices, and positive airway pressure devices. The latter is the most effective treatment and is very widely prescribed by sleep disorder practitioners for their patients. The general operation of these devices involves a remote pump which pushes air through a tube which is connected to a mask that covers the nose, mouth, or both. The mask is securely attached to the individual's face by straps and, due to the air being forced down the tube, the area between the mask and the face is kept at an elevated air pressure thus forcing air down the airway. The air-generating pump is run off mains electricity and is in general bulky and noisy. The tube connecting the pump to the mask restricts movement of the patient.

Many people who have sleep apnea are unable to tolerate the above treatment regimen. A common complaint is the dislike of the “umbilical” tube connecting the mask to the pump. The machines that are commercially available, using positive airway pressure, for sleep apnea are called continuous positive airway pressure, or CPAP, machines. A variant is called BiPAP (bilevel positive airway pressure) in which the air pressure can take on varying values depending on the breathing cycle of the patient. Technical aspects of these devices are disclosed in patents issued to Rapoport (U.S. Pat. No. 4,655,213).

One previous device and method for the treatment of sleep apnea is described in U.S. Pat. No. 4,655,213 to Rapoport in which positive air pressure is applied to the patient's airways (CPAP). U.S. Pat. No. 6,763,828 to Arnott discloses an apnea treatment device in which the pressure of exhaled air is used to assist in forcing air into the patient when the patient inhaled.

A problem with these devices is that they rely on remote air compressors and a cumbersome tube to facilitate the delivery of positive air pressure to the patient's airway. The present invention addresses these issues by eliminating the external compressor and external “umbilical” air tube by incorporating at least one air pressure generating device, e.g. a miniature air compressor or an electric fan, in and/or on the mask itself. Thus, the supply of pressurized air is generated by the mask itself. An increase in the air pressure is thus created directly by the mask.

One of the problems with the previously disclosed CPAP and BiPAP arrangements for the treatment of sleep apnea is that the patient is connected to a remote air pump by a tube which restricts the movement of the patient whilst asleep (or indeed awake). Further, many patients consider this arrangement so unattractive that they are resistant to using the mask and pump, thus compromising their health.

### SUMMARY OF THE INVENTION

According to one aspect of the present invention, the mask is not connected to a remote air pump. The mask itself generates increased air pressure by one or more miniature compressors, or similar air pressure generating devices that are, preferably incorporated into the mask and powered by batteries. Alternatively, the air pressure generating devices are mounted on a portion of the mask. The self-contained masks of the present invention comprise the entire positive airway pressure treatment system and, since there is no cumbersome tube connecting the patient to a remote pump, the patient is able to move about more freely when in bed.

The air pressure generating device is preferably powered by batteries which are located in the mask itself, or via a wire to batteries nearby the patient. The masks of the present invention enable the patient to be free of a cumbersome and unsightly “umbilical” air tube connected to a remote pump and thus is a very attractive treatment solution for people suffering from sleep apnea and other conditions requiring positive airway pressure treatment. Further, it reduces the overall size and weight of apparatus providing greater portability.

### BRIEF DESCRIPTION OF THE DRAWINGS

FIG. 1 is front perspective view of one embodiment of the present invention.

FIG. 2 is a partial side view of a portion of the apparatus shown in FIG. 1.

FIG. 3 is a partial cross-sectional view of the apparatus shown in FIG. 2.

FIG. 4 is a partial rear view of an alternative apparatus of the present invention.

FIG. 5 is a partial side view of an alternative embodiment of the present invention.

FIG. 6 is a partial side, perspective view of a further embodiment of the present invention.

FIG. 7 is a partial rear, perspective view of a further embodiment of the present invention.

FIG. 8 is a partial view of an alternative embodiment of the present invention.

FIG. 9 is a side perspective view of a still further embodiment of the present invention.

### DETAILED DESCRIPTION

The various embodiments of the present invention provide air pressure generating devices integral with a mask. As used herein, the term “air pressure generating device” is used to describe structure which utilizes a source of energy to increase the air pressure provided to the patient, such as an air compressor or a fan. The various embodiments of the present invention comprise at least one air pressure generating device which is integral with the mask and, as presently contemplated, is mounted within a portion of or on the housing of the mask.

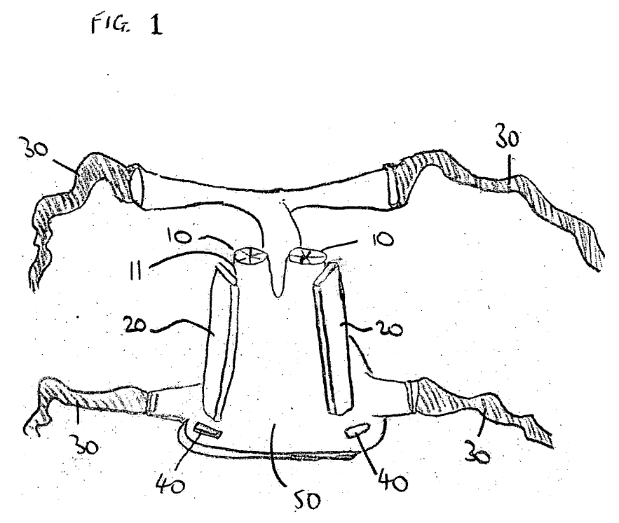

According to one embodiment of the present invention shown in FIG. 1, an apparatus of the present invention comprises a plurality of fans 10 mounted on air inlets 11 integral with a mask housing 50. This embodiment of the present invention comprises for adjustable straps 30 for securing the mask to the patient. This embodiment also comprises a plurality of batteries 20 mounted on an external surface of the mask housing 50 for powering the fans 10. In use, outside air is drawn into a chamber formed between the mask housing 50 and the patient's face by fans 10. According to this embodiment of the present invention, mask housing 50, when properly positioned, forms a chamber which, except as described herein, is sealed. This allows the desired positive pressure to be formed. The positive pressure keeps the nasalpharynx and oralpharynx open to facilitate patient airway patency. This embodiment of the present invention also comprises valves 40, which may include small open ports which allow exhaled air to escape. The valves 40 can comprise pressure sensors or be pressure actuated valves to control the air pressure within the mask, e.g. the valves can be designed to only allow egress of air after the pressure within the mask has reached a pre-selected pressure. Additionally, the pressure relief valves or pressure sensors can also be readily adjustable by the user for maximum comfort. The valve controls can be manually or electronically controlled.

Straps 30 go around the head holding the mask to the face. The mask can be attached either over the nose, mouth, or both the nose and mouth simultaneously. The air pressure generating devices of this and other embodiments of the present invention can provide continuous positive airway pressure (CPAP) or bi-level positive airway pressure (BiPAP) by the use of sensors and appropriate electronics, or by automatically adjusting levels of continuous positive air pressure based on the patients breathing (autotitrating CPAP). The levels of positive pressure can be manually or remotely adjusted, for example, from 2 cm to 22 cm of water. A supplemental oxygen port may also be incorporated into the mask.

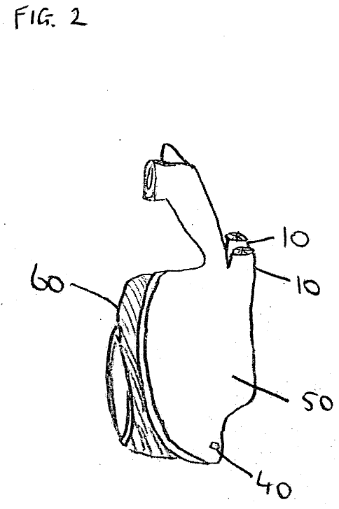

According to the illustrated embodiment of the present invention shown in FIG. 1, fans are positioned pointing upwardly so as to minimize the chance of being blocked. As shown in FIGS. 2-9, the air pressure generating devices used with the present invention, such as one or more fans or air compressors, can also be disposed at other positions on and/or in the mask. The portion of the mask housing 50 to which the air pressure generating device is connected, or which connects the air pressure generating device to the outside air, may also be directionally adjustable so as to minimize any blocking of the fans. The air pressure generating devices may also be positioned at other places on the mask, or additional fans may be positioned at other places on and/or in the mask as shown below.

One advantage of using a plurality of air pressure generating devices, such as the use of two fans 10 shown in FIG. 1 is that by separating the air inlets, the risk of all inlets becoming blocked at the same time is minimized. According to a preferred embodiment of the present invention, internal electronics detect blocked air ducts and increase the air flow generated by the remaining apgd(s) to compensate for the reduction of air pressure within the mask.

FIG. 2 is a partial side view of the embodiment shown in FIG. 1. FIG. 2 illustrates a gasket 60 which helps provide an airtight seal between the mask and a person's face.

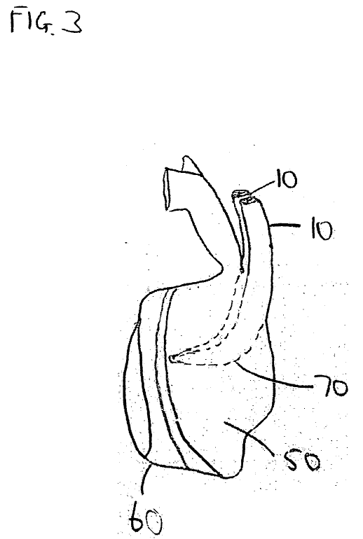

FIG. 3 illustrates an alternative embodiment of the present invention wherein tubes 70 extend from the chambers connected to fans 10 and extend to a mouthpiece (not shown) for directing air pressure directly into the patient's mouth. Thus, airway passageways can be utilized to direct pressurized incoming air directly to a patient's nose and/or mouth. This embodiment is particularly suitable for a patient who inhales more through his mouth, while exhaled air is directed into the interior chamber and vented to the outside.

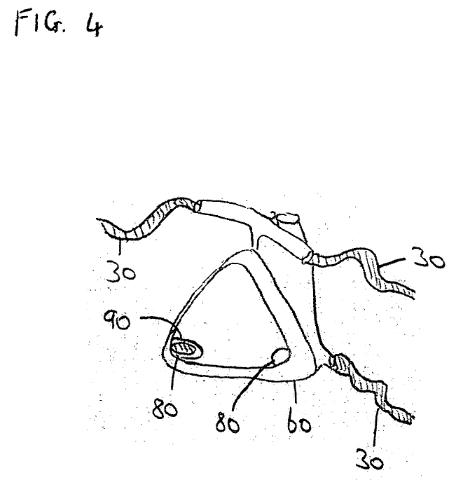

FIG. 4 illustrates an alternative embodiment of the present invention wherein compartments 90 provide chambers for supporting a substance which will enhance the air breathed by the patient and/or the air within the chamber formed between the mask and the patient's face. For example, a damp sponge 80 may be placed within a compartment 90 in order to increase the humidity of the air breathed by a patient. Water vapor released by the wet sponges will mix with the air being forced into the chamber formed by mask housing 50 by the fans and increase the humidity of the air traveling into the nose or mouth.

The mechanism for the locally generated positive air pressure in the mask may be of a type other than the fans described above, such as one or more small air compressors.

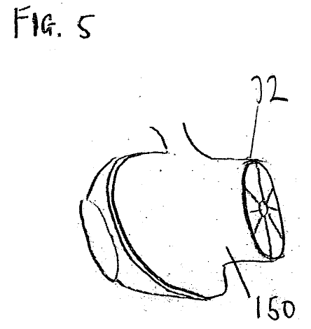

FIG. 5 illustrates an alternative embodiment of the present invention wherein a single fan 72 is positioned in the portion of the fan housing 150 which is proximate the nose of the patient when the mask is worn.

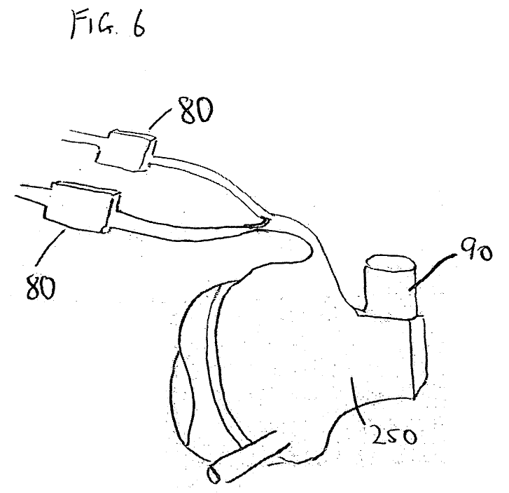

FIG. 6 illustrates an alternative embodiment of the present invention wherein a small air compressor 90 is integrally formed within mask housing 250. According to this embodiment of the present invention, battery packs 180 are mounted within the head straps of the mask. Preferably, such batteries are rechargeable and discharged batteries may be recharged without removing them from the mask.

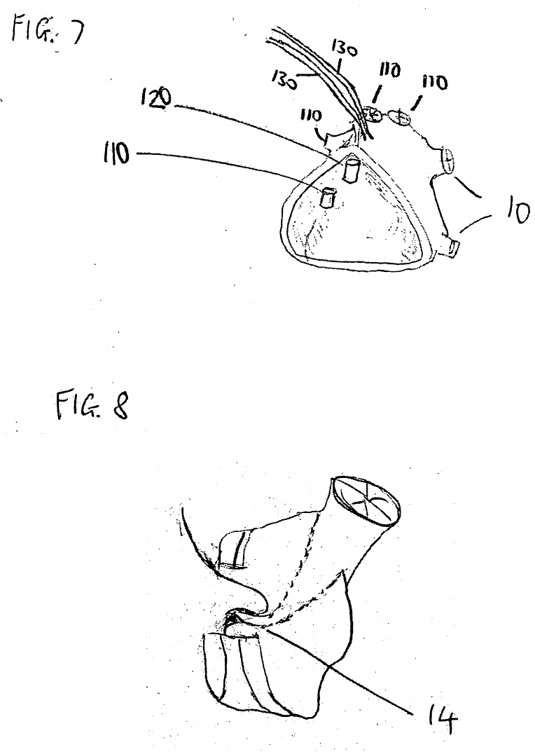

Alternatively, in less preferred embodiments, electrical supply wires may lead from the air pressure generating devices to a more remote battery pack or power service. For example, as shown in FIG. 7, relatively small electrical leads 130 can extend to a battery pack located on the headboard of a bed. FIG. 7 also illustrates air pressure sensors 110 and miniature electronic controls 120 for controlling the air pressure generating devices. The embodiment illustrated in FIG. 7 advantageously comprises five air pressure generating devices 110. From the present description drawings, it will be appreciated that wires or the electrical source can be significantly smaller than air hoses typically used with CPAP machines. These small electrical leads are believed to be significantly less objectionable than an air hose having, for example, a diameter of about one inch.

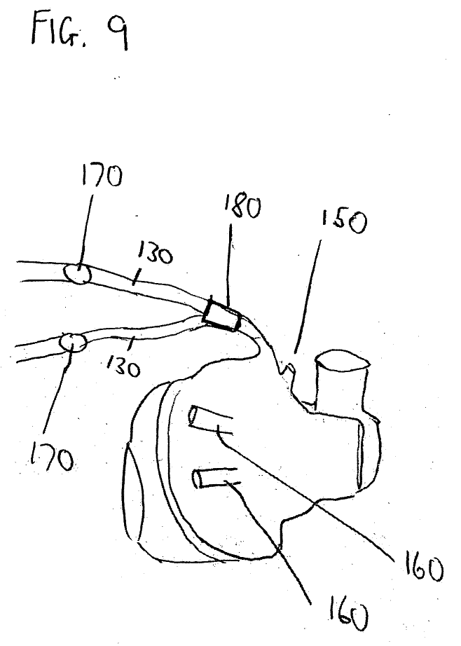

FIG. 8 illustrates an alternative embodiment of the present invention wherein the elevated-pressure incoming air can be connected via nasal connector 140 directly to the patient's nose. In this manner, the elevated air pressure incoming air is provided to the person's nose while used air is preferably exhaled through the mouth and vented to the outside.

In the embodiment illustrated in FIG. 9, a pair of small audio speakers 170 are connected to straps 130 to facilitate the production of an inverse sound wave to alleviate noise from the air pressure generating device (noise cancellation). The speakers and inverse sound wave electronics 180 can be powered by the same electrical source as the air pressure generating device. Alternatively the sound reduction device may be located remotely.

The embodiment of the present invention illustrated in FIG. 9 also comprises a port 150 for the introduction of external agents to be administered as desired.

The various mask apparatus of the present invention offer the advantages of portability and simplicity. No remote compressors or bulky connecting air tubes are needed since the mask itself directly and locally generates the positive air pressure. The small, relatively simple design will facilitate its use in almost any conditions, especially where main power is unavailable.

I claim:

1. An apparatus for providing increased air pressure to the nasopharyngeal airway comprising:
a mask comprising means for securing said mask to a patient's face covering at least one of the nasal openings or the mouth of said patient;
said mask comprising at least one air pressure generating device, integral to the mask, that generates positive air pressure directly inside the mask; and
a source of electrical power for said air pressure generating device.

2. An apparatus according to claim 1 wherein said air pressure generating device comprises at least one air compressor.

3. An apparatus according to claim 1 wherein said air pressure generating device comprises a plurality of air compressors.

4. An apparatus according to claim 1 wherein said air pressure generating device comprises at least one fan.

5. An apparatus according to claim 4 wherein said air pressure generating device comprises a plurality of fans.

6. An apparatus according to claim 1 further comprising electronics for detecting a blocked air pressure generating device and for increasing airflow generated by at least one other air pressure generating device.

7. An apparatus according to claim 1 wherein said source of electrical power is entirely supported by said mask.

8. An apparatus according to claim 7 wherein said source of electrical power comprises at least one battery.

9. An apparatus according to claim 8 wherein said at least one battery is a rechargeable battery.

10. An apparatus according to claim 7 wherein the batteries are supported by said securing means.

11. An apparatus according to claim 1 wherein said mask comprises reservoirs for water or other fluid.

12. An apparatus according to claim 1 wherein said securing means comprises at least one strap.

13. An apparatus according to claim 12 wherein the strap holding the mask to head may be secured to one of a plurality of places on the mask.

14. An apparatus according to claim 1 further comprising at least one speaker and associated electronics which generate a sound wave that is inverse to noise from said air pressure generating device in order to provide noise cancellation.

15. An apparatus according to claim 14 wherein said at least one speaker is mounted on said mask.

16. An apparatus according to claim 1 wherein said mask further comprises a port which allows external agents to be administered.

17. An apparatus according to claim 1 further comprising means for controlling the air pressure generated by said air pressure generating device.

18. An apparatus according to claim 17 wherein said controlling means are mounted on said mask.

19. An apparatus according to claim 17 wherein said controlling means are remotely operated.

20. An apparatus according to claim 1 wherein said air pressure generating device is powered by a remote source of electrical power which is connected to said air pressure generating device by at least one wire.
